(19) United States
(12) Patent Application Publication
(10) Pub. No.: US 2024/0123844 A1
(43) Pub. Date: Apr. 18, 2024

(54) STORAGE DEVICE AND METHOD FOR TRANSMITTING A DIRECT CURREN

(71) Applicant: Gerald Bode, Troisdorf (DE)

(72) Inventor: Gerald Bode, Troisdorf (DE)

(21) Appl. No.: 18/382,479

(22) Filed: Oct. 21, 2023

Related U.S. Application Data
(63) Continuation of application No. PCT/EP2022/060206, filed on Apr. 19, 2022.

(30) Foreign Application Priority Data
Apr. 21, 2021 (DE) DE102021110110.7

(51) Int. Cl. B60L 53/14; B60L 53/24; H02J 3/38; H02J 7/04

(52) U.S. Cl. CPC B60L 53/14; B60L 53/24; H02J 3/381; H02J 7/04; B60L 2210/40; H02J 2207/20

(57) ABSTRACT

A storage device comprising two pole storage elements for electrical charges; inverter groups including full bridges connected in series, wherein exactly one of the full bridges of each of the inverter groups is connected with poles of each of the storage elements; a control unit configured to determine storage status and optimize charge and discharge processes of the storage elements through the full bridges based on a respective storage status; and a respective two pole connection at each of the inverter groups. The control unit includes control modules connected in a network, wherein each of the control modules determines the storage status of exactly one of the storage elements and optimizes a charging and discharging process of the exactly one of the storage elements, wherein the control modules are connected by a data bus, further characterized by storage modules respectively including exactly one of the storage elements.

### RELATED APPLICATIONS

This application is a continuation of International patent application PCT/EP2-2060206 filed on Apr. 19, 2022 claiming priority from German patent application DE 10 2021 110110.7 filed on Apr. 21, 2021, both of which are incorporated in their entirety by this reference.

### FIELD OF THE INVENTION

The invention relates to a storage device with two pole storage elements for electrical charges, comprising inverter groups including full bridges connected in series wherein exactly one of the full bridges of each of the inverter groups is connected with poles of each of the storage elements, and a control unit configured to determine storage status and optimize charge and discharge processes of the storage elements through the full bridges based on respective storage status, and a respective two pole connection at each of the inverter groups. The invention furthermore relates to a method for transmitting a current between a power unit and a storage device including two pole storage elements, at least two inverter groups including full bridges connected in series wherein exactly one of the full bridges of each of the inverter groups is connected with poles of each of the storage elements, and a control unit determining storage status and optimizing charge and discharge processes of the storage elements through the full bridges based on respective storage status, and a respective two pole connection at each of the inverter groups.

### BACKGROUND OF THE INVENTION

A generic storage device is known from DE 10 2014 213167 A1.

CN 208 112 522 U A proposes to supply one or plural consumers directly with alternating current or three-phase current from terminals of a storage device of this type including 3 inverter groups connected in parallel with the storage elements.

DE 10 2011 089 312 A1, DE 10 2012 223 484 A1, DE 10 2014 215 070 A1 and CN 108 183 622 A disclose storage devices with plural inverter groups including full bridges respectively connected with associated storage elements. DE 10 2012 209 179 A1, US 2013/0127251 A1 and DE 10 2017 124 126 A1 disclose storage devices respectively including a single inverter group including full bridges.

Exchangeable storage modules respectively including a battery and an integrated control unit, e.g. for mobile computers, cameras or drones are known in the art wherein the control unit monitors a battery status of the battery.

### BRIEF SUMMARY OF THE INVENTION

Thus, it is an object of the invention to simplify direct current transmission. Improving upon a known storage device it is proposed according to the invention that the control unit includes control modules connected in a network, wherein each of the control modules determines the storage status of exactly one of the storage elements and optimizes a charging and discharging process of the exactly one of the storage elements, wherein the control modules are connected by a data bus, further characterized by storage modules respectively including exactly one of the storage elements, one of the control modules configured to determine its storage status and optimize its charging and discharging process, and a bus connection configured to connect with the data bus, wherein the control module includes an interface with four control conductors to one of the full bridges, and a respective bypass configured to bridge each of the storage modules, wherein the full bridges are included in the storage modules and the control unit is configured to respectively provide a DC voltage at the connections of at least two of the inverter groups.

The inverter groups used in the known storage device can implement any desired waveform of current and voltage. Thus, the storage device according to the invention is suitable to receive and emit direct current directly at the two-pole connection, of the inverter group. The storage element can include different cells, in particular battery cells or capacitors or a combination of both or even pure energy sources or sinks.

The storage status describes the status of all cells, (e.g. for battery cells: “battery health”) of a storage element and includes state of charge (SoC), forecast values for possible emitted or received amounts of energy and threshold values for charge and discharge powers and currents that do not physically damage the cells and minimize degradation. In addition to a respectively measured voltage between the poles and the temperature of each cell, a history of these values stored in the control unit is used for determining the respective storage status.

In analogy to the storage status of the storage elements the control unit can also determine the respective full bridge status of each full bridge from its temperature and include it in the optimization. Alternatively, the full bridges of a storage device according to the invention can be oversized so that an overload cannot occur and monitoring the full bridge status is not needed.

Each full bridge, also H-bridge, here: four quadrant chopper, includes four power switch elements, advantageously four transistors connected in a known H-circuit. Four control conductors of the full bridge are respectively provided with a binary control voltage which respectively defines a switching condition of exactly one of the power switch elements. The power switch elements are connected with the poles of the storage element at an input side of the full bridge so that the poles on the output side are alternatively shortened, voltage free, as anode or cathode or reverse through the switching conditions of the power switching elements.

Advantageously the control unit in a storage device according to the invention includes control modules cross linked with each other, wherein each of the control modules measures a storage status of exactly one of the storage elements and optimizes its charging and discharging processes. Each control module digitizes and stores only analog measured values like voltage and temperatures of the storage cells and temperatures of the full bridges of the associated storage element and determines the secondary characteristic values like storage status and full bridge status therefrom. This modular storage device then only transmits these characteristic values required for a dynamic power control and energy flow control or explicitly requested data sets like diagnostic data to a superordinate central control system which splits a respective actual demand to the full bridges based on the characteristic values and data sets. This greatly reduces the data volume to be processed by the central control system compared to the prior art. Alternatively the control modules can determine and coordinate the current power and energy requirement independently without super ordinate central control system. Additionally the modular arrangement of the control unit facilitates replacement of a single defective storage element together with an associated storage module. For example, the history data of the storage elements is moved together with the control module when a storage module is replaced.

Advantageously the control modules are connected with one another in the storage device according to the invention, and optionally with a central control system through a data bus. Bus technology for transmitting data is well known in the art.

The storage device according to the invention includes storage modules respectively including exactly one of the storage elements, one of the control modules configured to determine its storage status and optimize its charging and discharging process, and a bus connection configured to connect with the data bus, wherein the control module includes an interface with four control conductors to one of the full bridges. In this storage module for a storage device including plural inverter groups the control module includes one interface per inverter group. The control module then optimizes charging and discharging processes of the storage module through all full bridges connected at the storage element. When the control module stores the storage condition of the storage element, the storage module can be removed from the storage device according to the invention and replaced.

When the inverter group is a hard-wired module of the storage device, the storage module can be separated from the associated full bridges under load during operation of the storage device according to the invention. In the storage device according to the invention the full bridges form part of the storage module. A storage capacity of a storage device according to the invention can be adapted to respective requirements by varying a number of storage modules. When removing a storage module from the storage device according to the invention or adding an additional storage module, the full bridges of adjacent storage modules are electrically disconnected. The disconnect can be bridged with a bypass in order to maintain the function of the inverter groups.

Advantageously the storage device according to the invention includes a switching device configured to connect the connections of the inverter groups. This storage device according to the invention has increased storage capacity and more power when absorbing or emitting energy.

Advantageously the storage device according to the invention has an AC power connection, connectable with plural, advantageously two of the inverter groups by the switching device alternatively to the connections. The storage device according to the invention can receive or provide direct current or alternating current for different energy sources or consumers as required.

Advantageously, the storage device according to the invention includes a three-phase power connection connectable with plural, advantageously three from the inverter groups by the switching device as an alternative to the star circuits, e.g. for domestic current, or the delta circuits, e.g. for start-up of a three-phase motor. The storage device according to the invention can absorb or provide direct current or three phase current for different energy sources or consumers.

Advantageously, the storage device according to the invention includes an auxiliary storage device which provides the central control with energy in particular. In the storage device according to the invention, the auxiliary energy storage device can be a storage element or a high-power capacitor for example.

The storage device according to the invention advantageously includes disconnect elements configured to advantageously disconnect one respective full bridge from one pole of an associated storage element, wherein each of the storage elements is hard wired with one of the full bridges at the most. When different full bridges at the same storage element are controlled by the inverter groups differences in potential between the inverter groups can cause ring currents. The ring currents are prevented by disconnecting individual full bridges by the disconnect elements.

For functionality it is sufficient when all full bridges besides one are disconnectable. This full bridge can be hard wired with the respective storage element, thus without disconnect element. In particular these hard-wired full bridges can be associated with a common inverter group. For simplification purposes all full bridges can be configured with respective disconnect elements. Controlling the disconnect elements in a respective storage module is performed by the control module. Each of the disconnect elements is connected with the control module through a control conductor.

Advantageously the storage device according to the invention is fabricated from storage modules wherein each storage module includes exactly one of the storage elements, one of the control modules for determining its storage status and optimization of its charging or discharging processes and a bus connection for connecting with the data bus, wherein the control module includes an interface with four control conductors to one of the full bridges. In one storage module for a storage device with plural inverter groups the control module includes one interface of this type per inverter group. The control module then optimizes charging and discharging processes of the storage through all full bridges arranged at the storage element. When the control module stores the storage status of the storage element, the storage module in the storage device according to the invention can be removed and replaced.

When the inverter group is a hard-wired module of the storage device, the storage module can be separated under load from the associated full bridges during operation of the storage device according to the invention. Alternatively, the full bridges can be part of the storage module. The storage capacity of a storage device according to the invention is easily adapted to the respective requirements by varying a number of the storage modules. When removing a storage module of this type from a storage device according to the invention or for completing an additional storage module, the full bridges of the adjacent storage modules are electrically disconnected. The disconnect can be bridged with a bypass in order to maintain the function of the inverter groups.

Advantageously, a storage device according to the invention is used in a motor vehicle including at least one electric motor, in a domestic electric storage device advantageously including at least one advantageously three phase low voltage connection or in a charging station including at least one single phase charging connection for an electrically operable motor vehicle.

Improving upon the known method it is proposed according to the invention that the current at the connections of at least two of the inverter groups is respectively transmitted as direct current. The method according to the invention can be performed by a storage device according to the invention and is characterized by the advantages recited supra.

The power unit in a method according to the invention is advantageously configured as a photovoltaic plant which simultaneously charges the storage device and a motor vehicle. The method according to the invention transmits energy captured by the photovoltaic plant to the motor vehicle without intermediary storage essentially without losses.

### BRIEF DESCRIPTION OF THE DRAWINGS

The invention is subsequently described based on embodiments with reference to drawing figures, wherein:

FIG. 1 illustrates a house according to the invention, a motor vehicle according to the invention and a charging station according to the invention;

FIG. 2A schematically illustrates charging a first storage device according to the invention, in a house with three phase current from a public low voltage grid;

FIG. 2B illustrates a storage module of the storage device;

FIG. 2C illustrates withdrawal of three phase or alternating current from the first storage device;

FIG. 3A illustrates transmission of direct current from a solar array to the first storage device;

FIG. 3B illustrates transmission of direct current from a solar array to the first storage device with simultaneous charging of a motor vehicle;

FIG. 4 illustrates a second storage device according to the invention in the motor vehicle; and

FIG. 5 illustrates a third storage device according to the invention in the charging station.

### DETAILED DESCRIPTION OF THE INVENTION

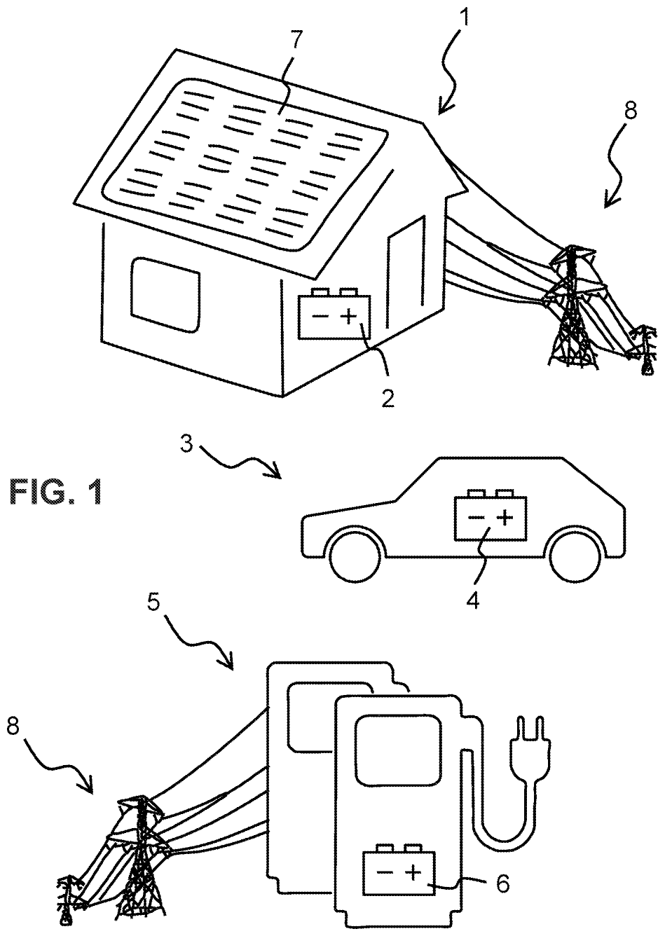

FIG. 1 illustrates a house 1 according to the invention including a first storage device 2, a motor vehicle 3 according to the invention with a second storage device 4 according to the invention and a charging station 5 according to the invention with a third storage device 6 according to the invention.

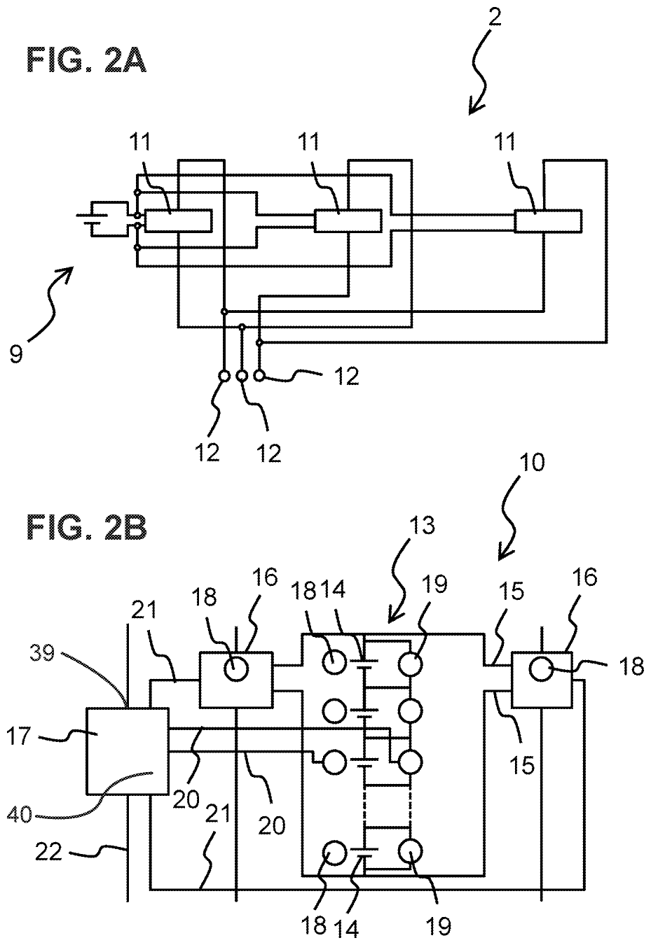

The house 1 includes a photovoltaic plant 7 (20 kWp, Usmpp: 700 V, Impp: 3×8 A) and is connected to the public low voltage grid 8 (400 VAC, 40 A, three phase 50 Hz). The first storage device 2 schematically illustrated in FIG. 2A includes a storage group 9 with 34 storage modules 10, six inverter groups 11, (only 3 of the inverter groups 11 are shown) at the storage group 9, a non-illustrated auxiliary storage device (LiFePO₄) and a non-illustrated central control. For charging from the low voltage grid 8 the three phases 12 of the low voltage grid 8 are connected with the inverter groups 11 in a delta circuit.

Each of the storage modules 10 illustrated in detail in FIG. 2B includes a storage element 13 (25.6 V) made from eight battery cells 14 (Li-ion) with 3.2 V each connected in series, six full bridges 16, connected in parallel at the poles 15 of the storage element 13 (only two of the full bridges 16 are illustrated in a simplified representation), and a control module 17, and a respective temperature sensor 18 at each battery cell 14 and at the full bridges 16 and a voltage sensor 19 at each battery cell 14. The control module 17 is connected by data conductors 20 with the temperature sensors 18 and the voltage sensors 19 and by control conductors 21 with the full bridges 16 and by a data bus 22 with the central control system. The interface 40 of the control module 17 with the full bridges 16 is hard wired through data conductors 20 and the control conductors 21. The full bridges 16 are connected with the respective inverter group 11 and the control module 17 is connected with the data bus 22 through non-illustrated plug-in connections.

A non-illustrated micro controller in the control module 17 processes all measurement values of temperatures and voltages of the battery cells 14 and the full bridges 16 provided in the storage module 10, computes secondary values like powers and energy amounts from global measurement values like e.g. the inverter group current. Individual values and results are stored in a non-illustrated data memory in the control module 17 and used for determining the amount of energy Soc (state of charge) stored in the storage element 13. The control module 17 provides the SoC and the current temperatures at the data bus 22, receives control commands from the central control system through the data bus 22, checks and evaluates them with respect to permissibility of the switching condition and controls the full bridges 16 accordingly.

In order to supply three phase consumers with 400 VAC and one phase consumers with 230 VAC in house 1, conductors for three phases 23 and the ground (neutral) conductor 24 of the house grid (400 VAC 50 Hz, three phase) are connected with the inverter groups 11 in a star circuit as illustrated in FIG. 2C.

In order to prevent ring currents due to differences in potential between inverter groups 11 simultaneously connected with a storage element 13, the full bridges 16 are individually disconnected from the respective storage element 13 by a non-illustrated disconnect element when this particular storage element 13 is not used in the respective inverter group 11. The full bridge 16 bridges the respective storage element 13 in order to maintain current flow in the inverter group 11.

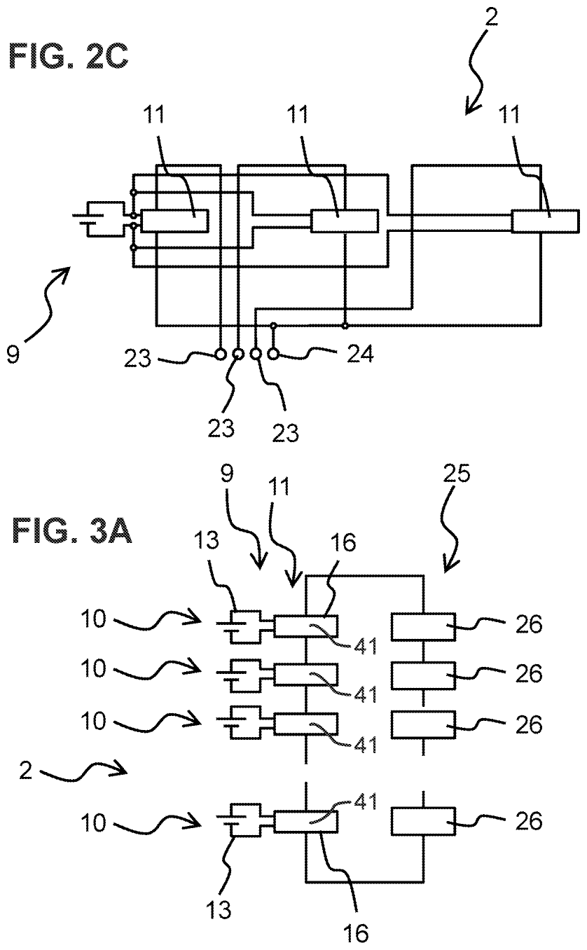

In order to charge the battery cells 14 of the storage elements 13 in FIG. 3A from the photovoltaic plant 7, three strings 25 (Umpp: 28 V, Uoc: 35 V) each including 25 photovoltaic modules 26 (Pmpp: 260 W) of the photovoltaic plant 7 are each connected in parallel with one of the inverter groups 11. For simplification purposes only one connection is shown. Thus, each of the strings 25 can be regulated independently into an optimum operating point using the MPPT-method. In the optimum operating point each of the strings 25 delivers a peak power of 6.5 kW at Usmpp=700 VDC.

Depending on the solar exposure, the temperature of the photovoltaic modules and the state of charge (Soc) of the storage elements 13, the optimum operating point shifts continuously. Since the MPPT controller of an inverter group 11 does not know the disturbance variables of solar exposure and temperature, the operating point has to be determined continuously using an iteration method. For this purpose, several load points above and below the actual load point have to be approached by modulating the output voltage Vsout of the inverter group 11 and the associated total power has to be computed by the central control system. The output voltage associated with the highest power is subsequently used as a new optimum operating point. The iterative load point determination starts again with this new load point. The switching sequence of the storage modules 10 and control of Vsout is optimized to provide continuous current burden of the storage modules 10 and balancing of the energy flows.

FIG. 3B shows how the motor vehicle 3 is charged simultaneously with charging the storage device 2 from the photovoltaic plant 7. Thus, all inverter groups 11 are connected to the same storage elements 13. The strongly fluctuating voltage of the photovoltaic plant 7 from zero to 875 V is controlled by three of the inverter groups 11 in the respectively MPPT power optimum and the energy is stored at 700 VDC and 3×8 A per inverter group 11 for fractions of seconds into the storage elements 13. Thus, up to 28 of the storage elements 13 are connected. Simultaneously three other inverter groups 11 extract this energy at 400 VDC and 41 A. For this purpose, 16 of the storage element 13 are connected.

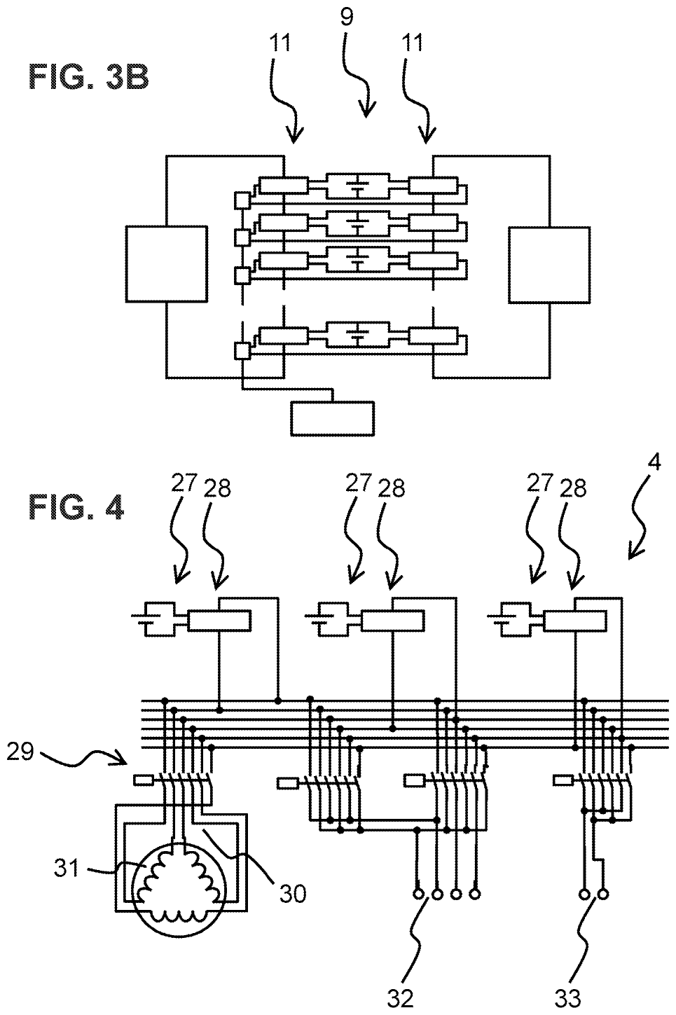

The second storage device 4 illustrated in detail in the motor vehicle 3 illustrated in FIG. 4 includes three storage groups 27 with a respectively connected inverter group 28 and a non-illustrated control module and a switching device 29 for switching the inverter groups 28 between a three-phase connection 30 for the motor 31 (690 VAC, three phase, 0-100 Hz, 100 kW) of the motor vehicle 3, another AC connection 32 for one phase or three phase charging and a DC connection 33.

The full bridges of the inverter groups 28 are hard wired into a module, the storage modules of the storage groups 27 are respectively only made from one storage element and one control module with interfaces to the respective full bridges.

During driving of the operations of the motor vehicle 3 only the motor 31 is switched on. Thus, each inverter group 28 supplies exactly one motor winding. The phase voltage of the motor 31 is 690 volts in order to minimize currents to significantly below 100 A. The three phase AC voltage is synthesized with respect to voltage and frequency in both energy flow directions.

During DC charging operations utilizing the DC connection 33 the motor vehicle 3 permits an input voltage range of 30 V to 870 V at a charging current of 0-500 A at maximum power point and internally distributes the energy between the individual storage elements 13 by itself. This yields a maximum charging power of 350 kW.

During DC grid storage operation, a freely selectable voltage and power can be retrieved from the motor vehicle 3 or stored therein through the DC connection 33 according to CSS integration alternating level 3—V2H. In this operating mode the connection to the first storage device 2 according to the invention is established.

A direct coupling of two motor vehicles 3 for direct DC based energy exchange is possible through the DC connection 33. Thus, each motor vehicle 3 selects storage elements based on negotiated charging voltage and current.

All inverter groups 28 are supplied with the voltage of 230 VAC respectively for charging from a type F socket through the AC connection 32. The input voltage can be between 30 and 870 V at 0 to 100 Hz.

Each of the three inverter groups 28 is supplied in a star circuit with 230 V from the external grid for charging at a typical 3 phase outlet or directly by the CCS standard compatible plug through the AC connection 32. At 400 VAC phase to phase voltage the maximum charging power at the current point in time is only limited by the valid CCS standard to 43 kW at 63 A and 400 VAC.

A non-illustrated adapter facilitates isolated operation of one or three phase consumers through the AC power connection 32 directly from the motor vehicle 3. The adapter is connected with the motor vehicle 3 through a CCS plug and the associated cable.

A non-illustrated adapter facilitates direct connection of a photovoltaic plant 7 to the motor vehicle 3 through the DC connection 33 without a detour through the first storage device 2 according to the invention or external power rectifiers.

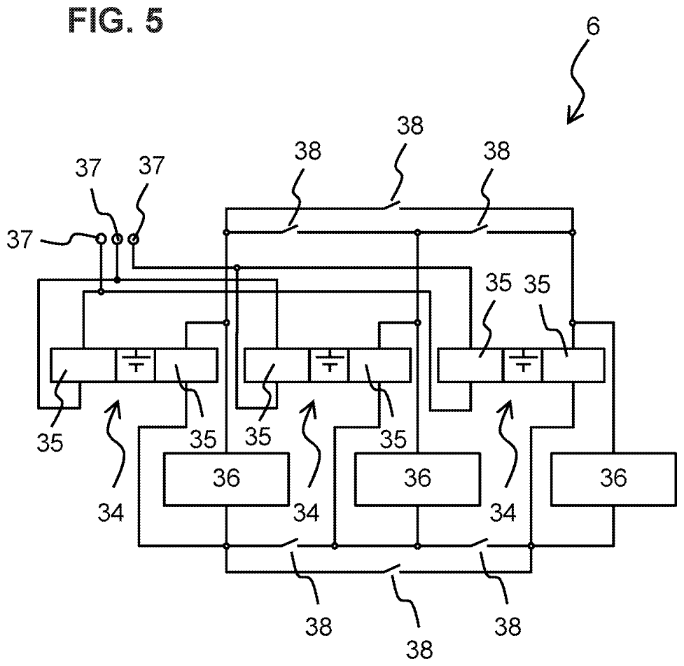

The storage device 6 shown in detail in FIG. 5 includes three storage groups 34, each having two inverter groups 35 and three charging connections 36 and is connected in turn to the public low voltage grid 8. The grid connection power is between 43 kW and 150 KW depending on the capacity of the energy supply grid. The input voltage of the charging station 5 can be between 90 and 690 VAC at 15-60 Hz. The possible charging power for the motor vehicle 3 is up to 350 kW in any case at a charging voltage of up to 800 VDC, independently from the grid connection parameters. Thus, the charging station 5, permits a much higher charging power to the motor vehicle 3 of up to 350 kW than provided by the low voltage grid 8 at a minimum of 43 kW.

The three phases 37 of the low voltage grid 8 are connected with three of the inverter groups 35. The energy is stored in the storage groups 34 proportionally. Three additional inverter groups 35 draw the energy from the storage groups 34 simultaneously and generate a continuously variable direct voltage therefrom, which can be regulated at a full nominal current of 500 A from 30-870 V.

To make optimum use of the installed power of the total system in a typical application and in order to reduce the power losses, the DC output current of 500 A is distributed to the storage groups 34 with 170 A each by switch elements 38. Each storage group 34 supplies an independent CCS charging connection 36 so that three motor vehicles 3 at the most can be charged simultaneously respectively at up to 68/135 kW at 400/800 VDC.

When only one CCS connection is being used the power of the two other storage groups 34 can be connected in parallel through the switch elements 38 and thus an individual motor vehicle 3 can be charged with up to 200/350 kW. When two motor vehicles 3 are connected one can be charged with up to 135/270 kW and the other one can be charged with up to 68/135 kW. The storage groups 34 are dynamically connected in parallel through the switching elements 38 during the charging process without the user having to interrupt the charging process.

A non-illustrated additional storage device according to the invention corresponds essentially to the third storage device 6 according to the invention. However, capacitors are used as storage elements instead of battery cells. In this storage device according to the invention, the maximum charging power corresponds to the grid connection power, thus 350 kW.

Compared to the third storage device 6 according to the invention, these storage devices have a reduced total weight and significantly smaller housing dimensions with significantly reduced acquisition and operating costs. However, there is no ability to push out more energy into a motor vehicle 3, e.g. 100 kWh, over a longer period of time, e.g. 40 minutes, than can be provided at a connection power of e.g. 43 kW by a weak low voltage grid.

### REFERENCE NUMERALS AND DESIGNATIONS

1 house
2 storage device
3 motor vehicle
4 storage device
5 charging station
6 storage device
7 photovoltaic plant
8 low voltage grid
9 storage group
10 storage module
11 inverter group
12 phase connection
13 storage element
14 battery cell
15 pole
16 full bridge
17 control module
18 temperature sensor
19 voltage sensor
20 data conductors, control conductors
21 control conductors
22 data bus
23 phase conductor
24 ground (neutral) conductor
25 string
26 photovoltaic module
27 storage group
28 inverter group
29 switching device
30 three-phase connection
31 motor
32 AC connection
33 DC connection
34 storage group
35 inverter group
38 charging connection
37 phase connection
38 switching element
39 bus connection
40 interface
41 bypass

What is claimed is:

1. A storage device comprising:
two pole storage elements for electrical charges;
inverter groups including full bridges connected in series, wherein exactly one of the full bridges of each of the inverter groups is connected with poles of each of the two pole storage elements;
a control unit configured to determine a respective storage status and optimize charge and discharge processes of the two pole storage elements utilizing the full bridges based on the respective storage status of the two pole storage elements; and
a respective two-pole connection at each of the inverter groups,
wherein the control unit includes control modules connected in a network,
wherein each of the control modules determines the storage status of exactly one of the storage elements and optimizes a charging and discharging process of the exactly one of the storage elements,
wherein the control modules are connected by a data bus;
storage modules respectively including exactly one of the two pole storage elements, exactly one of the control modules configured to determine the storage status of the exactly one of the two pole storage elements and optimize a charging and discharging process of the exactly one of the two pole storage elements; and
a bus connection configured to connect with the data bus,
wherein the control module includes an interface with four control conductors to one of the full bridges, and a respective bypass configured to bridge each of the storage modules, and
wherein the full bridges are included in the storage modules and the control unit is configured to respectively provide a DC voltage at the respective two pole connections of at least two of the inverter groups.

2. The storage device according to claim 1, further comprising: a switching device configured to connect the respective two pole connections of the inverter groups.

3. The storage device according to claim 2, further comprising an AC connection connectable with two or more of the inverter groups by the switching device alternatively to the respective two pole connections of the inverter groups.

4. The storage device according to claim 2, further comprising: a three-phase connection connectable with three or more of the inverter groups by the switching device in a star circuit or a delta circuit alternatively to the respective two pole connections of the inverter groups.

5. The storage device according to claim 1, further comprising: an auxiliary energy storage device.

6. The storage device according to claim 1, further comprising:
disconnect elements configured to disconnect at least one pole of one respective full bridge from an associated two pole storage element,
wherein each of the two pole storage elements is hard wired with one of the full bridges at the most.

7. An electrically operable motor vehicle; comprising:
at least one electric motor;
an electrical domestic energy storage including at least one three phase low voltage connection or charging station including an at least one at least one phase charging connection for the electrically operatable motor vehicle including the storage device according to claim 3.

8. A method comprising:
transmitting a current between a power unit and a storage device,
wherein the storage device includes two pole storage elements, inverter groups including full bridges connected in series, wherein exactly one of the full bridges of each of the inverter groups is connected with poles of each of the two pole storage elements;
determining storage status and optimizing charging and discharging processes of the two pole storage elements through the full bridges based on a respective storage status of the two pole storage elements by a control unit; and
a respective two-pole connection at each of the inverter groups,
wherein the control unit includes control modules connected in a network,
wherein each of the control modules determines the storage status of exactly one of the two pole storage elements and optimizes a charging and discharging process of the exactly one of the two pole storage elements,
wherein the control modules are connected by a data bus;
storage modules respectively including exactly one of the two pole storage elements, exactly one of the control modules configured to determine the storage status of the exactly one of the two pole storage elements and optimize a charging and discharging process of the exactly one of the two pole storage elements,
wherein the control module is connected with one of the full bridges by four control conductors, wherein each of the storage modules is configured to be bridged by a respective bypass, and
wherein the full bridges are included in the storage modules and the current is respectively transmitted at the two pole connections of at least two of the inverter groups as direct current.

9. The method according to claim 8, wherein the power unit is a photovoltaic plant that simultaneously charges the storage device and a motor vehicle.

10. A storage device comprising:
two pole storage elements for electrical charges;
inverter groups including full bridges connected in series, wherein exactly one of the full bridges of each of the inverter groups is connected with poles of each of the two pole storage elements;
a control unit configured to determine a respective storage status and optimize charge and discharge processes of the two pole storage elements utilizing the full bridges based on the respective storage status of the two pole storage elements; and
a respective two-pole connection at each of the inverter groups,
wherein the control unit includes control modules connected in a network,
wherein each of the control modules determines the storage status of exactly one of the storage elements and optimizes a charging and discharging process of the exactly one of the storage elements,
wherein the control modules are connected by a data bus;
storage modules respectively including exactly one of the two pole storage elements, exactly one of the control modules configured to determine the storage status of the exactly one of the two pole storage elements and optimize a charging and discharging process of the exactly one of the two pole storage elements; and
a bus connection configured to connect with the data bus,
wherein the control module includes an interface with four control conductors to one of the full bridges, and a respective bypass configured to bridge each of the storage modules, and
wherein the inverter group is a hard-wired module of the storage device and the control unit is configured to respectively provide a DC voltage at the respective two pole connections of at least two of the inverter groups.
